(19) United States
(12) Patent Application Publication
(10) Pub. No.: US 2005/0280914 A1
(43) Pub. Date: Dec. 22, 2005

(54) Retry reordering in hard disk drives

(76) Inventors: Yeong Kyun Lee, San Jose, CA (US); Gyu Taek Kim, San Jose, CA (US); Young Dug Jung, San Jose, CA (US); Kang Seok Lee, San Jose, CA (US)

Correspondence Address: IRELL & MANELLA LLP, 840 NEWPORT CENTER DRIVE, SUITE 400, NEWPORT BEACH, CA, 92660, US

(21) Appl. No.: 10/873,658

(22) Filed: Jun. 21, 2004

(51) Int. Cl. G11B 27/36; G11B 5/09

(52) U.S. Cl. 360/31; 360/53

(57) ABSTRACT

A hard disk drive that updates a retry look-up table to be commensurate with a successful retry read operation. The drive may contain a retry look-up table that contains a plurality of retry steps. Each retry step may have a different read parameter that is changed in an attempt to read data that initially created an error. The controller will reset the look-up table by swapping an N retry step with a N-1 retry step if the N step is successful in reading the data greater than a predetermined number of times. In the next retry cycle the drive will reach the N step sooner in the cycle than before the steps were swapped, thus possibly reducing the time required to successfully read the data.

### BACKGROUND OF THE INVENTION

1. Field of the Invention

The present invention relates to a technique for reading data from a disk of a hard disk drive.

2. Background Information

Hard disk drives contain a plurality of magnetic heads that are coupled to rotating disks. The heads can magnetize and sense the magnetic fields of the disk to write and read data, respectively. The heads are coupled to a pivoting actuator arm that has a voice coil motor.

Data is typically stored on tracks that extend radially across the disk surfaces. The voice coil motor can be energized to pivot the actuator arm and move the heads to different track locations. Each track is typically divided into a number of sectors. Each sector contains at least one data field.

Data is read from the disks in accordance with a read operation controlled by the disk drive controller. The read operation typically includes enabling a read gate of a read channel. Enabling the read gate causes the heads to sense the magnetic fields of the disks. If the drive is unsuccessful in reading the data, the controller will retry the read operation in accordance with a retry step from a retry look-up table. The retry look-up table typically contains a sequence of retry steps. Each retry step may utilize different head parameters. For example, the read current and cut-off frequency of the head may be changed for each step.

The disk drive will continue to retry the read operations in accordance with the retry steps until the data is successfully read from the disk or the drive has tried all of the retry steps in the table. Having to sequentially retry each step can be an inefficient process for reading the data. For example, the look-up table may contain the retry steps A, B, C and D. Each retry step may have a different head parameter(s). Given certain operating conditions the drive may only be able to read data with the parameters of step D. Given the techniques of the prior art, the drive must retry steps A-C before trying step D. It would be desirable to increase the efficiency of reading data from a disk of a hard disk drive.

### BRIEF SUMMARY OF THE INVENTION

A hard disk drive with a controller that controls a read operation of a disk. The controller retries the read operation in accordance with a series of retry steps and swaps at least a pair of the retry steps if a retry is successful in reading the disk a predetermined number of times.

### BRIEF DESCRIPTION OF THE DRAWINGS

FIG. 1 is a top view of an embodiment of a hard disk drive;

FIG. 2 is a schematic of an electrical circuit for the hard disk drive;

FIG. 3 is a flowchart showing a retry process for reading data from a disk of the disk drive.

### DETAILED DESCRIPTION

Disclosed is a hard disk drive that updates a retry look-up table to be commensurate with a successful retry read operation. The drive may contain a retry look-up table that contains a plurality of retry steps. Each retry step may have a different read parameter that is changed in an attempt to read data that initially created an error. The controller will reset the look-up table by swapping an N retry step with a N-1 retry step if the N step is successful in reading the data greater than a predetermined number of times. In the next retry cycle the drive will reach the N step sooner in the cycle than before the steps were swapped, thus possibly reducing the time required to successfully read the data.

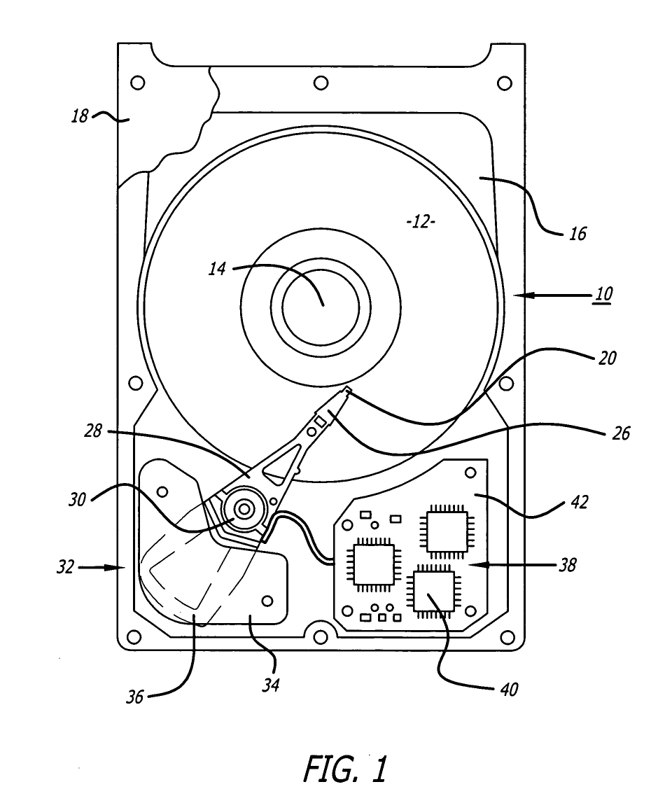

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

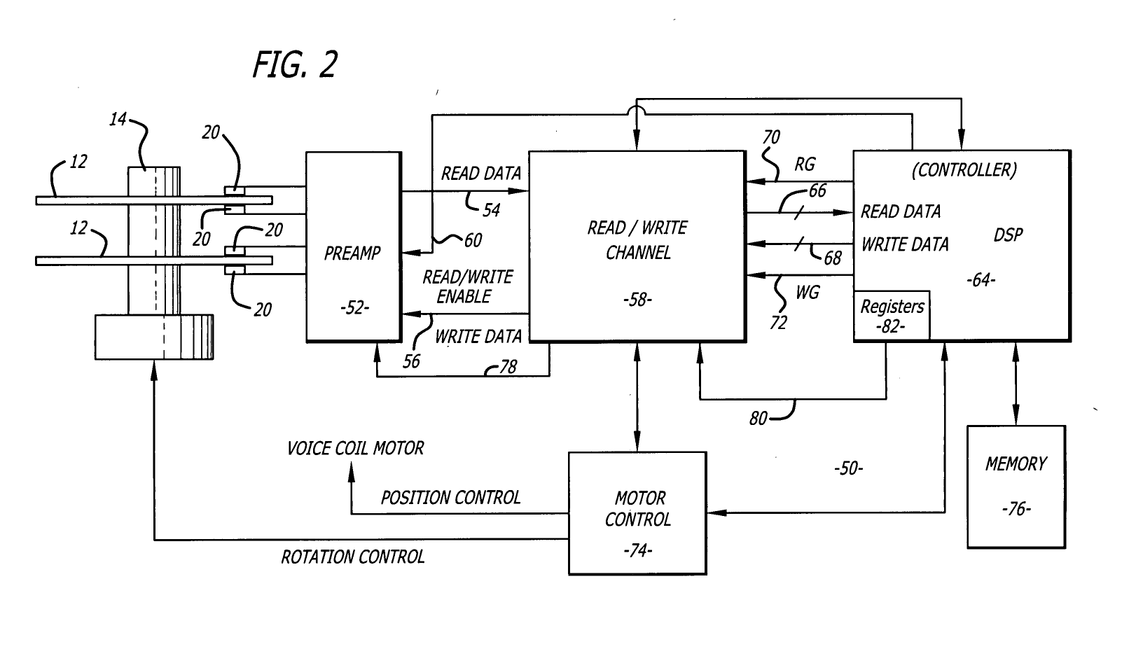

FIG. 2 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a firmware and/or software routine(s), including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the firmware and/or software routine(s) performed by the controller.

The pre-amp 52 and read channel 58 typically have a number of different read parameters such as read current, cut-off frequency, signal boost, finite impulse response (“FIR”) coefficient, off track and signal symmetry. The values of these parameters can be set through lines 78 and 80. Although single lines 78 and 80 are shown, it is to be understood that there may be multiple lines between the controller 64, read channel 58 and pre-amp 52. The values may be stored in registers 82 of the controller 64.

Memory 76 and/or disk 12 may contain a retry look-up table that has a plurality of retry steps. The retry steps are performed to read data from the disk. Each step may change one or more read parameters stored in the registers 82. The steps are typically performed sequentially until the data is successfully read from the disk. Although a look-up table is described, it is to be understood that the retry steps can be generated in accordance with an algorithm.

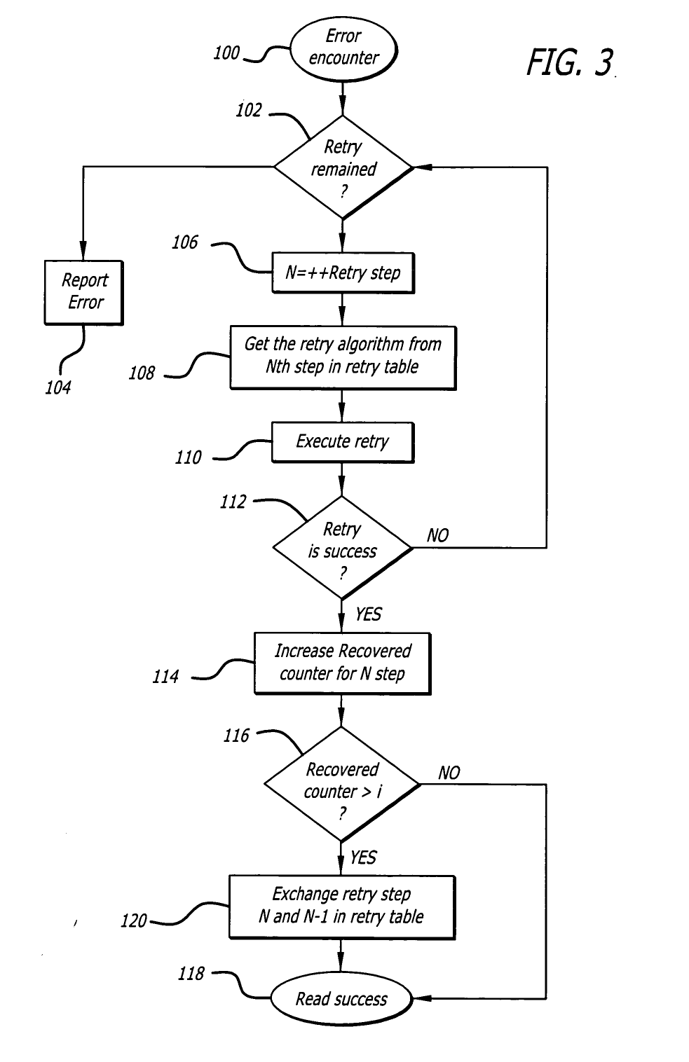

FIG. 3 is a flowchart showing a retry process for reading data from the disk. In process block 100 the drive has attempted a read operation of the disk which resulted in an error. It is then determined whether there is an available retry step in decision block 102. If there are no more retry steps an error report is generated in block 104.

If there is a retry step available the next retry step in the look-up table is set as the Nth step in block 106. The retry algorithm associated with the Nth step is retrieved from the look-up table in block 108. The algorithm can provide new read parameters that are utilized by the read channel and head to read the data.

The drive executes a read operation of the data sector(s) that generated the error in block 110. Decision block 112 determines whether the data was successfully read during the read operation. If the data was not successfully read the process returns to block 102 where the drive retries the read operation with the next retry step in the look-up table.

If the read operation was successful a recovery counter is incremented in block 114. Decision block 116 determines whether the count value is greater than a defined number i. By way of example, i may be the number 5. If the recovery counter's count value does not exceed i then the process is completed in block 118. If the count value does exceed i then steps N and N-1 are swapped in the look-up table in block 120 and the counter for step N is reset to zero. Decision block 116 can be implemented to insure that a certain number of successful retry operations are performed with step N before rearranging the look-up table.

By way of example, the look-up table may have retry steps A, B, C and D. If step D successfully reads data more than i times then steps C and D are swapped and the new order of the look-up table is A, B, D and C. If step D again successfully reads data more than i times the order become A, D, B and C. The next time the drive must retry the read operation step D is used without trying steps B and C. This reduces the time required to successfully read the data.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A hard disk drive, comprising:
a disk;
a spindle motor that rotates said disk;
a head coupled to said disk;
an actuator arm coupled to said head;
a voice coil motor coupled to said actuator arm; and,
a controller coupled to said head, said controller controls a read operation of said disk, said controller retries said read operation in accordance with an order of retry steps and swaps at least a pair of said retry steps in said order if a retry step successfully reads said disk a predetermined number of times.

2. The disk drive of claim 1, wherein said head has at least one variable read parameter that is changed between at least two retry steps.

3. The disk drive of claim 2, wherein said variable read parameter is a read current.

4. The disk drive of claim 2, wherein said variable read parameter is a cut-off frequency.

5. The disk drive of claim 2, wherein said variable read parameter is a finite impulse response coefficient.

6. The disk drive of claim 2, wherein said controller includes a register that contains a value for said variable read parameter.

7. The disk drive of claim 1, wherein said controller retries in accordance with an N step in a retry table and swaps the N step with an N-1 step if the N step successfully reads said disk greater than said predetermined number of times.

8. The disk drive of claim 7, wherein said controller counts each successful N step and resets the N step counter to zero if said N step is successful in reading said disk greater than said predetermined number of times.

9. A hard disk drive, comprising:
a disk;
a spindle motor that rotates said disk;
a head coupled to said disk;
an actuator arm coupled to said head;
a voice coil motor coupled to said actuator arm; and,
controller means for controlling a read operation of said disk and retrying said read operation in accordance with an order of retry steps and swapping at least a pair of said steps in said order if a retry step successfully reads said disk a predetermined number of times.

10. The disk drive of claim 9, wherein said head has at least one variable read parameter that is changed between at least two retry steps.

11. The disk drive of claim 10, wherein said variable read parameter is a read current.

12. The disk drive of claim 10, wherein said variable read parameter is a cut-off frequency.

13. The disk drive of claim 10, wherein said variable read parameter is a finite impulse response coefficient.

14. The disk drive of claim 10, wherein said controller means includes a register that contains a value for said variable read parameter.

15. The disk drive of claim 9, wherein said controller retries in accordance with an N step in a retry table and swaps the N step with an N-1 step if the N step successfully reads said disk greater than said predetermined number of times.

16. The disk drive of claim 15, wherein said controller counts each successful N step and resets the N step counter to zero if said N step is successful in reading said disk greater than said predetermined number of times.

17. A hard disk drive, comprising:
a disk;
a spindle motor that rotates said disk;
a head coupled to said disk;
an actuator arm coupled to said head;
a voice coil motor coupled to said actuator arm;
a controller coupled to said head; and,
a memory that contains a program which causes said controller to control a read operation of said disk so that said controller retries said read operation in accordance with an order of retry steps and swaps at least a pair of said retry steps if a retry step successfully reads said disk a predetermined number of times.

18. The disk drive of claim 17, wherein said head has at least one variable read parameter that is changed between at least two retry steps.

19. The disk drive of claim 18, wherein said variable read parameter is a read current.

20. The disk drive of claim 18, wherein said variable read parameter is a cut-off frequency.

21. The disk drive of claim 18, wherein said variable read parameter is a finite impulse response coefficient.

22. The disk drive of claim 18, wherein said controller includes a register that contain values for said variable write parameter.

23. The disk drive of claim 17, wherein said controller retries in accordance with an N step in a retry table and swaps the N step with an N-1 step if the N step successfully reads said disk greater than said predetermined number of times.

24. The disk drive of claim 23, wherein said controller counts each successful N step and resets the N step counter to zero if said N step is successful in reading said disk greater than said predetermined number of times.

25. A method for reading data from a disk of a hard disk drive, comprising:
performing a read operation to read a disk with a head;
retrying the read operation in accordance with a retry step; and,
swapping the retry step with another retry step if the retry step is successful in reading the disk a predetermined number of times.

26. The method of claim 25, wherein the head has at least one variable read parameter that is changed before retrying the read operation.

27. The method of claim 26, wherein the variable read parameter is a read current.

28. The method of claim 26, wherein the variable read parameter is a cut-off frequency.

29. The method of claim 26, wherein the variable read parameter is a finite impulse response coefficient.

30. The method of claim 26, wherein the variable read parameter is read from a register.

31. The method of claim 25, wherein the retry is performed in accordance with an N step in a retry table and the N step is swapped with an N-1 step if the N step successfully reads the disk greater than the predetermined number of times.

32. The disk drive of claim 31, wherein each retry is counted by a counter and the counter resets the N step counter to zero if the N step is successful in reading the disk greater than the predetermined number times.
